(19) United States
(12) Patent Application Publication
(10) Pub. No.: US 2008/0103321 A1
(43) Pub. Date: May 1, 2008

(54) Processes to make phosphate salt containing products

(75) Inventors: Dustin K. James, Sugar Land, TX (US); C. Edward Baxter, League City, TX (US)

Correspondence Address: BRACEWELL & GIULIANI LLP, P.O. BOX 61389, HOUSTON, TX, 77208-1389, US

(73) Assignee: EnviroFuels LLC, Houston, TX (US)

(21) Appl. No.: 11/977,760

(22) Filed: Oct. 26, 2007

Related U.S. Application Data
(60) Provisional application No. 60/854,594, filed on Oct. 26, 2006.

(51) Int. Cl. C07F 9/02

(52) U.S. Cl. 554/78

(57) ABSTRACT

The present invention provides a continuous process for producing an oil based phosphate containing product. The continuous process includes mixing water with at least one base and an orthophosphoric acid to produce a liquid phosphate salt containing solution. This solution is then dried, granulated, and mixed with a base stock hydrocarbon to form the oil based phosphate containing product.

### RELATED APPLICATIONS

This application claims priority from co-pending U.S. Provisional Application No. 60/854,594, filed Oct. 26, 2006, the full disclosure of which is hereby incorporated by reference herein

### BACKGROUND OF THE INVENTION

1. Field of the Invention

The present invention relates to improved processes for making phosphate salt containing products.

2. Description of Related Art

Phosphate salt containing products are useful for, among other uses, creating derivatized metal surfaces in engine and combustion chambers and as fuel additives for combustion. Previously, these phosphate salt containing products could be produced by a batch process. For example, potassium hydroxide, ammonium hydroxide, water and a phosphoric acid/acetic acid mix could be combined in an acid base reaction in a batch reaction vessel to produce an aqueous phosphate salt containing product.

Batch processes, however, suffer from a number of disadvantages. For example, batch processes can be difficult to duplicate, with variations from batch to batch occurring due to different feed rates, changing temperature profiles, different feed stocks, different operators, and possible contamination from other processes that are run in the same equipment. Also, large capital expenditures for equipment are typically used to produce products in a batch operation. In addition, large batch reactions are more difficult to control, especially in the case of exothermic acid/base reactions such as those that are sometimes used to prepare phosphate salt containing solutions.

Another drawback to previous processes is that the presence of water in some phosphate salt containing products is essentially an inactive ingredient, and adds to the cost of shipping the solution from one location to another due to the increased volume. Accordingly, it would be useful to produce phosphate salt containing products by a continuous process that minimizes or eliminates free water.

Moreover, the phosphate salts contained in the previous compositions are relatively large, e.g., greater than 5,000 microns. As a result, they take time to dissolve in the fuel or otherwise take longer to combust, thereby reducing the efficacy of the phosphate salt products as fuel additives.

Additionally, many newer, high-tech engines employ high pressure fuel injection nozzles. These fuel injection nozzles contain smaller apertures than older models, which means that any particulates in the fuel must also be smaller in order to prevent the nozzles from plugging. To combat this issue, engine makers are using finer fuel filters, as fine as one micron. Therefore, for the phosphate salts to pass through the filter and effectuate their purpose, the diameter of the phosphate salts must be less than one micron.

U.S. patent application Ser. Nos. 10/768,613 and 60/613,699 describe the mixing of aqueous phosphate salt containing product with one or more liquid hydrocarbon base oils. These applications are hereby incorporated by reference in their entireties. The phosphate salt containing product is mixed with the liquid hydrocarbon base oils in a batch process to produce a hydrocarbon-based phosphate salt containing product that is more easily dispersible in hydrocarbon oils.

TABLE 1 illustrates an example of a raw material balance for a batch process to make a phosphate salt containing solution in accordance with the prior art.

TABLE I

| | | | | | | | | lb-mole |
|---|---|---|---|---|---|---|---|---|
| | Raw | | Density | | | % | lb- | Acid or |
| Stream # | Materials | FW | (lb/gal) | Gallons | lb | Active | mole | Base |
| 1 | 75% H₃PO₄ | 97.99 | 13.20 | 492 | 6490 | 75% | 49.67 | 149.00 |
| 2 | 99.8% AcOH | 60.15 | 8.75 | 76 | 663 | 99.8% | 11.02 | 11.02 |
| 6 | H₃PO₄/AcOH | | | 567 | 7,153 | | | |
| | Mix | | | | | | | |
| 3 | DI H₂O | 18.01 | 8.34 | 935 | 7802 | 100.0% | 433.07 | |
| 4 | 45% KOH | 56.10 | 12.09 | 569 | 6875 | 45% | 55.14 | 55.14 |
| 5 | 28.4% | 35.05 | 7.48 | 442 | 3302 | 28.4% | 26.76 | 26.76 |
| | NH₄OH | | | | | | | |
| Total of | | | | 1,945 | 17,979 | | | |
| mixture | | | | | | | | |
| of 3, 4, 5 | | | | | | | | |
| 8 | Product | | 10.30 | 2,513 | 25,132 | | | |

FIG. 1 illustrates a process flow diagram corresponding to the raw material balance for a batch process shown in TABLE I. The stream numbers shown in the process flow diagram are the same as those shown in the raw material balance. The acid to base ratio of Stream #1 is 1.95. DI H₂O is deionized water.

Thus, a need exists for a process for the production of phosphate salt containing solutions for creating conversion surfaces or other uses that produces consistent product reliably and with good quality control. A need further exists for a continuous process for the production of phosphate salt containing solutions for creating conversion surfaces or other uses that reduces capital expenditures in comparison to batch processing. A need also exists for a process for making phosphorous salts in solid forms that can be used to make phosphate salt containing solutions for creating conversion surfaces or other uses without excess water. It is also desirable that the making of solid forms of phosphorous salts that can be used to make water-free phosphate salt containing solutions are created by a continuous process.

It is also desirable to create a dispersion of very small nano-sized particles (for example, particles with sizes less than about 100 nm in diameter) of the phosphorous salts. Nano-sized particles in liquids are clear, the solid particles being invisible to the eye. It is also desirable to create a nano-sized particle dispersion in which no chemical dispersant additive is needed to keep the nano-sized particles suspended due to their light weight.

A need also exists for a process for making nano-sized particles of a phosphate containing salt product. One or more of these needs are addressed by the present inventions.

### SUMMARY OF THE INVENTION

The present invention is directed to a process that satisfies at least one of these needs. The present invention provides a continuous process for producing an oil based phosphate containing product. This first embodiment, known as the “dry/exothermic” process, includes mixing a predetermined amount of water, [Y]OH, [Z]OH, and AcOH in a first mixer to create a base stream, wherein [Y] is a cation and [Z] is selected from the group consisting of NH₄, NHOH and an amine. This base stream is then mixed with an orthophosphoric acid using a second mixer to create a liquid phosphate salt containing solution, wherein the orthophosphoric acid is selected from the group consisting of [Y]H₂PO₄, [Y]HPO₄, [NH₄]₂HPO₄, and combinations thereof, wherein [Y] is a cation.

The liquid phosphate salt containing solution is then passed through a pH analyzer in order to determine the pH of the liquid phosphate salt containing solution. The liquid phosphate salt containing solution's pH is then compared to a predetermined liquid phosphate pH value. The present invention also provides a means for adjusting the pH of the liquid phosphate salt containing solution operable to modify the pH of the liquid phosphate salt containing solution within a preselected range of the predetermined liquid phosphate pH value. Preferably, the value should be around 7.0, with the range being plus or minus about 1.0, more preferably a value of 7.0 with a range of plus or minus about 0.5, and most preferably a value of 7.1 with a range of plus or minus about 0.1.

The liquid phosphate salt containing solution is then passed through a suitable drying and granulating chamber to create a water based vapor stream and a substantially water-free solid phosphoric salt product. At this point, the substantially water-free solid phosphoric salt product consists of a plurality of particles. This plurality of particles has a distribution of particle sizes, with a substantial amount of the particles having a diameter smaller than about 100 nanometers. Preferably, an in-line particle classifier is included so that any large particles (particles that exceed a predetermined size in diameter) can be removed from the process stream and be recycled back into the first mixer.

The product from the drying and granulating chamber is then mixed with a base stock hydrocarbon using a high shear mixer to form the final product, which is an oil based phosphate containing product. As stated earlier, this entire process is conducted continuously, which provides many advantages over the prior art.

In another embodiment, known as the “wet/exothermic” process, the process is identical to the “dry/exothermic” process up to and including the pH analyzer. However, rather than passing through a drying chamber, the liquid phosphate salt containing solution is mixed with a base stock hydrocarbon using a wet high shear mixer to form an emulsified water-in-oil mixture. This emulsified mixture is then sent to a drying evaporator, wherein a substantial amount of the water is removed, leaving a substantially water-reduced emulsified mixture. However, it is important to note that the mixture contains an effective amount of water to promote water of hydration. This is particularly important for the stability of the mixture. Too much water creates a water phase, whereas too little water causes the particles to settle out. In order to ensure that there is an effective amount of water left in the substantially water-reduced emulsified mixture, the process includes a water content analyzer, which determines the water content of the mixture and also provides a means for adjusting the water content of the mixture. For instance, the water content analyzer could be in communication with devices that could either alter the flow rate of the inlet stream of the drying evaporator, the residence time of the mixture within the evaporator, or the temperature of the evaporator.

The substantially water-reduced emulsified mixture then enters a wet grinder, wherein the suspended phosphate particles are grounded into preferably nanoparticles that are also suspended in the mixture, resulting in an oil based phosphate containing product. This oil based phosphate containing product has a plurality of particles, with a substantial amount of the particles having a diameter of less than about 100 nanometers. Preferably, a wet particle analyzer is included following this step in order to analyze the diameters of the plurality of particles of the oil based phosphate containing product. More preferably, this wet analyzer would be in communication with a means for adjusting the diameters of the plurality of particles of the oil based phosphate containing product. Possible means for adjusting the diameters include altering the flow rate of the inlet to the wet grinder and/or altering the conditions inside the wet grinder. Again, this entire process is conducted in one continuous fashion.

In a preferred embodiment of the present invention, the phosphorus content of the liquid phosphate salt containing solution is measured using a first p-count analyzer and compared to a predetermined liquid phosphate phosphorus value. Additionally, a means for adjusting the phosphorus content of the liquid phosphate salt containing solution that is operable to modify the phosphorus content of the liquid phosphate salt containing solution within a preselected range of the predetermined liquid phosphate phosphorus value is provided.

Moreover, an additional embodiment provides for determining the phosphorus content of the oil based phosphate containing product using a second p-count analyzer and comparing the phosphorus content of the oil based phosphate containing product to a predetermined oil based phosphorus value. Additionally, a means for adjusting the phosphorus content of the oil based phosphate containing product operable to modify the phosphorus content of the oil based phosphate containing product within a preselected range of the predetermined oil based phosphorus value is provided.

Furthermore, an additional embodiment provides for determining the phosphorus content of the emulsified water-in-oil mixture using a second wet p-count analyzer and comparing the phosphorus content of the emulsified water-in-oil mixture to a predetermined emulsified water-in-oil phosphorus value. Additionally, a means for adjusting the phosphorus content of the emulsified water-in-oil mixture operable to modify the phosphorus content of the emulsified water-in-oil mixture within a preselected range of the predetermined water-in-oil phosphorus value is provided.

Additionally, in another aspect, the present invention includes a method, called a “salts form,” of producing phosphate salt appropriate for dispersal into a base stock hydrocarbon using a continuous process. Just as the “exothermic” embodiments have a “wet” and a “dry” version, so too does the “salts form” of the process. The primary difference between the “exothermic” and “salts form” embodiments being the ingredients mixed. In the salts form, water is mixed with various salts, rather than aqueous solutions, to create an intermediate solution. These salts include [Y]H₂PO₄, [Y]₂HPO₄, [NH₄]₂HPO₄, [X]C₂H₃O₂, [NR₄]₂HPO₄, [Y]₂NH₄PO₄, [Y][NH₄]₂PO₄, and [Z]₂B₄O₇, wherein [Y] is a cation, [X] is a cation and/or NH₄, R is hydrogen and/or an alkyl group, and [Z] is a cation. Just like the exothermic process, the intermediate solution (which is analogous to the liquid phosphate salt containing solution of the exothermic embodiments), passes through a pH analyzer in order to determine the pH of the intermediate solution. The intermediate solution's pH is then compared to a predetermined liquid phosphate pH value. The present invention also provides a means for adjusting the pH of the intermediate solution operable to modify the pH of the intermediate solution within a preselected range of the predetermined liquid phosphate pH value.

In the “dry/salts form” embodiment of the process, the steps after mixing the salts together are identical to the “dry/exothermic” embodiment discussed above, with the intermediate mixture being analogous to the liquid phosphate salt containing solution.

In the “wet/salts form” embodiment of the process, the steps after mixing the salts together are identical to the “wet/exothermic” embodiment discussed above, again with the intermediate mixture being analogous to the liquid phosphate salt containing solution.

In the “salts form” of the embodiment, the process preferably includes utilization of a phosphate salt containing solution containing [Y]H₂PO₄, [Y]₂HPO₄, and water or other solvents as components of an intermediate solution, where Y is a cation. The cationic portion of the salt components can be any cation, with potassium being a preferred cation. In this case, the preferred components would be KH₂PO₄, K₂HPO₄, and water. The intermediate solution is mixed with a carrier fluid. The carrier fluid is any fluid operable to maintain the salts in at least a partially dispersed state within the carrier fluid. Another group of preferred cations would be the alkali metals of Group IA of the Periodic Table of Elements.

While orthophosphoric acids have been described, it is to be understood that orthophosphoric acids include pyrophosphoric acids, which are the condensed analogs of orthophosphoric acid. The difference being that, through the process to condense the orthophosphoric acid, the PO₄³⁻ becomes P₂O₇²⁻ or other condensed phosphates. Therefore, [Y]H₂PO₄, [Y]HPO₄ and [NH₄]₂HPO₄ are precursors to pyrophosphoric acids. The use of the pyrophosphoric form is therefore encompassed within the definition of the orthophosphate form, which can be expressed as [Y]H₂PO₄, [Y]HPO₄ and [NH₄]₂HPO₄ and in similar form.

In another embodiment, the phosphate salt containing solution is used to create a dry product through the addition of [NH₄]₂HPO₄ to the intermediate solution of [Y]H₂PO₄, [Y]HPO₄, and water or other solvent. Yet another embodiment includes the addition of NH₄C₂H₃O₂ where C₂H₃O₂-ion is an acetate group such that the solution contains [Y]H₂PO₄, [Y]HPO₄, [NH₄]₂HPO₄, NH₄C₂H₃O₂ and water. When the solution is prepared using ammonium compounds, ammonium compounds being defined as those compounds containing NHx groups, the nitrogen in the solution is essentially all in the form of ammonium ions. There is at most a negligible amount of free ammonia.

In an embodiment of the present invention, aqueous boron salt containing products may also be utilized. The invention preferably includes a boron-containing salt that includes [Z]₂B₄O₇, wherein Z is a cation. Ammonium is a preferred inorganic cation. Alkali metals are another preferred inorganic cation, more preferably those alkali metals with atomic weights under 50.0. This creates a boron salt appropriate for dispersal into a hydrocarbon base stock hydrocarbon and is encompassed in the term dry product.

Another embodiment of the present invention includes making the phosphate salt containing product in a continuous process, drying the continuously made phosphate salt containing product in a continuous process, and continuously suspending the resulting solid in base stock hydrocarbon to make an oil based phosphate containing product.

Another embodiment of the present invention includes mixing and grinding the solid forms of the phosphorous salts, i.e., solid K₂HPO₄, KH₂PO₄, KOAc, K₂(NH₄)PO₄, and K(NH₄)₂PO₄ to a powder in a continuous process, and continuously suspending the powdered product in base stock hydrocarbon. Preferably, the solid powdered product includes nano-sized phosphate salt particles.

Another embodiment of the present invention includes using liquid phosphate salt containing solution in a continuous process to make solid phosphate salt containing product via continuous drying, and subsequently directly using this product as an additive to fuel products.

Another embodiment of the present invention includes using liquid salts phosphate salt containing product made in a continuous process to make solid phosphate salt containing product via a continuous drying process, and directly using the resulting solid product as an additive in solid fuel products.

Another embodiment of the present invention includes mixing and grinding the solid forms of the phosphate salt containing product phosphorous salts, i.e., solid K₂HPO₄, KH₂PO₄, KOAc, K₂(NH₄)PO₄, and K(NH₄)₂PO₄ to a powder in a continuous process, and directly using the powdered product as an additive to solid fuel components. Preferably, the solid powdered product includes nano-sized phosphate salt particles.

### BRIEF DESCRIPTION OF THE DRAWINGS

So that the manner in which the features, advantages and objects of the invention, as well as others which will become apparent, may be understood in more detail, a more particular description of the invention briefly summarized above may be had by reference to the embodiment thereof which is illustrated in the appended drawings, which form a part of this specification. It is to be noted, however, that the drawings illustrate only a preferred embodiment of the invention and are therefore not to be considered limiting of the invention's scope as it may admit to other equally effective embodiments.

FIG. 1 is a simplified flow diagram of a process for production of a phosphate salt containing product in accordance with a prior art process;

FIG. 2 is a simplified flow diagram of the “dry” embodiment of a continuous process for production of an oil based phosphate containing product according to an embodiment of the present invention;

FIG. 3 is a simplified flow diagram of the “wet” embodiment of a continuous process for production of an oil based phosphate containing product according to an embodiment of the present invention;

FIG. 4 is a simplified flow diagram of at least a portion of a continuous process for production of a liquid phosphate salt containing solution according to an embodiment of the present invention;

FIG. 5 is a simplified flow diagram of at least a portion of a continuous process for production of a liquid phosphate salt containing solution in accordance with another embodiment of the present invention;

FIG. 6 is a simplified flow diagram of at least a portion of a continuous process for production of a liquid phosphate salt containing solution in accordance with another embodiment of the present invention; and

FIG. 7 is a simplified flow diagram of a process for drying a phosphate salt containing product to produce a solid product in accordance with an embodiment of the present invention.

### DETAILED DESCRIPTION OF THE DRAWINGS

For simplification of the drawings, figure names and numbers are the same in the figures for various streams and equipment when the functions are the same or similar, with respect to the streams or equipment, in each of the figures. Like numbers refer to like elements throughout.

The various processes that are envisioned in embodiments of this invention are outlined as follows, and detailed descriptions will be made of various unit operations used in these processes.

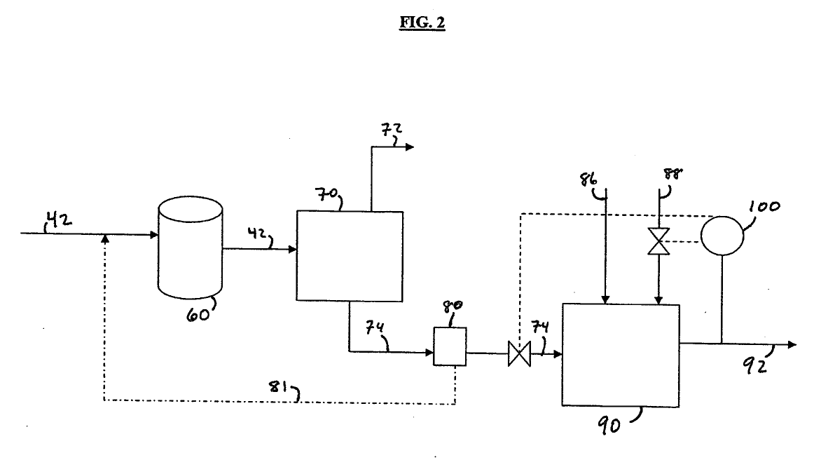

Now turning to FIG. 2, which is a preferred embodiment of the “dry” continuous process, the liquid phosphate salt containing solution [42] is fed into a liquid phosphate salt containing solution run down tank [60]. The liquid phosphate salt containing solution run down tank [60] is provided to minimize the impact of variations upstream. The liquid phosphate salt containing solution [42] moves from the liquid phosphate salt containing solution run down tank [60] and into a drying chamber [70]. In the present embodiment, a drying operation is used to treat the liquid phosphate salt containing solution [42] to produce a substantially water free solid phosphate salt product [74].

Methods of producing solids from liquids using unit operations such as spray drying are processes known in the pharmaceutical sciences and in other industries where solids are the final product forms, such as disclosed in: Kudra, T.; Mujumdar, A. S. “Advanced Drying Technologies” Marcel Dekker, New York, 2002; and Masters, K. “Spray Drying Handbook” Fourth Edition, John Wiley & Sons, New York, 1985, the disclosures of which are incorporated herein in their entirety.

In spray drying, the process steps as disclosed in the cited literature include atomization of the solution; spray-air contact; drying of droplets/sprays; and separation and recovery of dried product. It is understood that there are many variations in these basic steps that are all intended to be part of this disclosure. Other drying technologies that are intended to be included in this disclosure include drying on inert particles (including coal or other solid fuel particles); impinging stream drying; drying in pulsed fluid beds; superheated steam drying; airless drying; drying in mobilized bed; drying with shock waves; vacuum jet drying system; contact-sorption drying; sonic drying; pulse combustion drying; and heat-pump drying. Some selected techniques for drying and dewatering include the Carver-Greenfield process; drying in a plasma torch; displacement drying; vapor drying; slush drying; atmospheric freeze-drying; radio frequency drying with 50-Ohm technology; radio-frequency-assisted heat pump drying; radio-frequency-vacuum drying; microwave-convective drying; microwave-vacuum drying; filter mat drying; spray-fluid bed-vibrated fluid bed drying; combined filtration and drying; and other hybrid technologies. A preferred method of drying is spray drying.

During this drying step, a water based vapor stream [72] is removed, leaving a substantially water free solid phosphate salt product [74]. The substantially water free solid phosphate salt product [74] then enters a particle classifier [80], wherein overly large particles [81] are removed and recycled back into the process, preferably at or before the first mixer [30].

In an alternate embodiment, the large particles [81] can be fed into a grinder (not shown) and then introduced back into the process just after the drying chamber [70]. Suitable mechanical processes for the grinding can include, but are not limited to, ball or media mills, cone and gyratory crushers, disk attrition mills, colloid and roll mills, screen mills and granulators, hammer and cage mills, pin and universal mills, impact mills and breakers, jaw crushers, jet and fluid energy mills, roll crushers, disc mills, and vertical rollers and dry pans.

The substantially water free solid phosphate salt product [74] now enters a high shear mixer [90] where it is mixed with a base stock hydrocarbon stream [88] to form an oil based phosphate containing product [92]. Preferably, dispersants [86] are also added into the high shear mixer [90]. Additionally, a second p-count analyzer [100] is provided in order to determine that the proper amount of phosphorus is in the oil based phosphate containing product [92]. In a preferred embodiment, the second p-count analyzer [100] is in communication with control valves that can control the flow rates of the base stock hydrocarbon stream [88] and the substantially water free solid phosphate salt product [74].

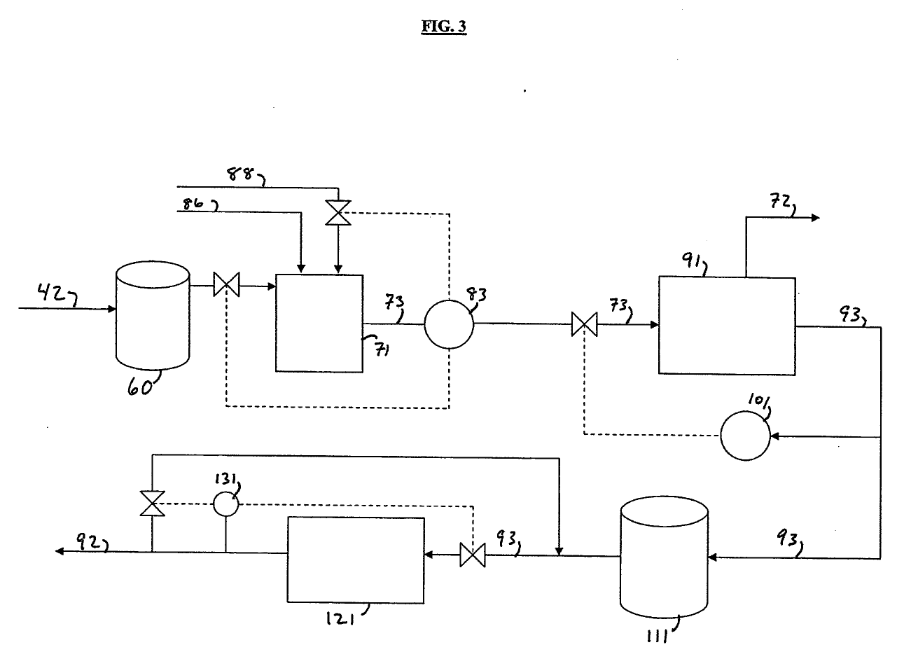

Now turning to FIG. 3, which is a preferred embodiment of the “wet” continuous process, the liquid phosphate salt containing solution [42] is fed into a liquid phosphate salt containing solution run down tank [60]. The liquid phosphate salt containing solution run down tank [60] is provided to minimize the impact of variations upstream. The liquid phosphate salt containing solution [42] moves from the liquid phosphate salt containing solution run down tank [60] and into a wet high shear mixer [71], where it is mixed with a base stock hydrocarbon stream [88] to form an emulsified water-in-oil mixture [73]. Preferably, dispersants [86] are also added into the wet high shear mixer [71]. Additionally, a second wet p-count analyzer [83] is provided in order to determine that the proper amount of phosphorus is in the emulsified water-in-oil mixture [73]. In a preferred embodiment, the second wet p-count analyzer [83] is in communication with control valves that can control the flow rates of the base stock hydrocarbon stream [88] and the liquid phosphate salt containing solution [42].

The emulsified water in oil mixture [73] then enters a drying evaporator [91], where a substantial amount of water is removed in the form of a water based vapor stream [72], leaving a substantially water free emulsified mixture [93] as the product stream of the drying evaporator. A water content analyzer [101] is provided to determine the water content of the substantially water free emulsified mixture [93]. Furthermore in one embodiment, the water content analyzer [101] is in communication with a control valve that controls the flow rate of the emulsified water-in-oil mixture into the drying evaporator [91]. Other possible methods for controlling the amount of water in substantially water free emulsified mixture [93] include adjusting the temperature of the drying chamber [70] or adding more water directly into the substantially water free emulsified mixture (not shown). The substantially water free emulsified mixture [93] then travels to a wet run down tank [111]. From the wet run down tank [111] the substantially water free emulsified mixture [93] travels into a wet grinder [121] where the particles are ground, preferably into nanoparticles, to form an oil based phosphate containing product [92]. A wet particle analyzer [131] is provided to determine the particle sizes of the plurality of particles within the oil based phosphate containing product [92]. Furthermore, a means for adjusting the diameters of the plurality of particles is provided by adjusting the flow of the substantially water free emulsified mixture [93].

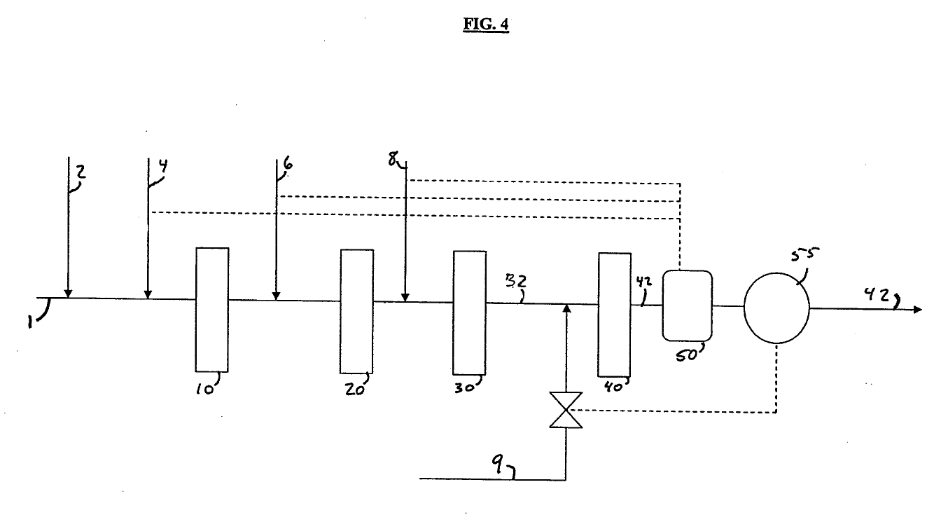

FIGS. 4-6 are all embodiments of the continuous process to produce the liquid phosphate salt containing solution [42] that is the inlet stream for both FIG. 2 and FIG. 3.

In FIG. 4, a continuous process is advantageously provided for producing a liquid phosphate salt containing solution [42]. In a preferred embodiment of this continuous process, a pipe [1] is used for the reaction; water [2] and KOH [4] are introduced into the pipe [1] and fed through a first premixer [10]. NH₄OH [6] is added to the pipe [1] and fed through a second premixer [20]. AcOH [8] is introduced into the pipe [1] and fed into a first mixer [30], creating a base stream [32]. Next, H₃PO₄ is fed into the pipe [1] and fed into a second mixer [40] to form a liquid phosphate salt containing solution [42]. A pH analyzer [50] is provided in order to determine the pH of the liquid phosphate salt containing solution [42], and it is in communication with the feed pumps (not shown) of KOH [4], NH₄OH [6], and/or AcOH [8], so that the pH of the liquid phosphate salt containing solution [42] is within the range of about 6.0 to about 8.0, more preferably about 6.5 to about 7.5, and most preferably about 7.0 to about 7.2.

Additionally, the phosphorus content of the liquid phosphate salt containing solution [42] is measured using a first p-count analyzer [55]. The first p-count analyzer [55] is in communication with the feed pump of the H₃PO₄ feedstock (not shown), so that it can adjust the flow rate of H₃PO₄ so that it is within a preselected range of a predetermined liquid phosphate phosphorus value. The liquid phosphate salt containing solution [42] then travels to a liquid phosphate salt containing solution run down tank [60] as shown in FIGS. 2-3.

All feedstocks are fed into the pipe [1] by feed pumps (not shown) at a rate such that the desired ratios of components are obtained in the final product. The pipe [1] is constructed of a material appropriate for the reaction, and the diameter of the pipe can be varied to allow for the volume of the feedstocks. Scaling up the process can be accomplished, for example, by adding a second parallel process stream or upsizing the equipment to allow for greater flow rates.

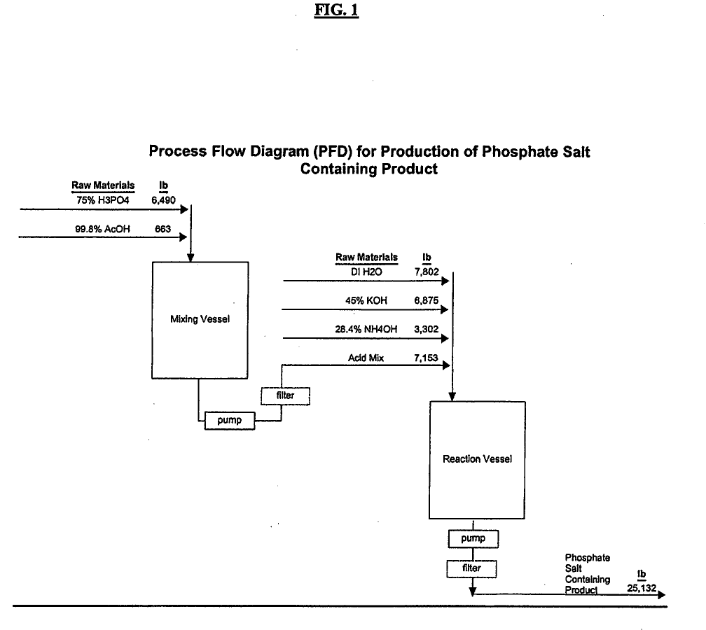

In the embodiment shown in FIG. 4, the continuous process is preferably based on the material balance and process flow diagram for the prior art batch process, as shown in FIG. 1. In the continuous process, according to one embodiment, approximately 935 gallons per hour (gph) of water is pumped into the inlet of the pipe. Next approximately 569 gph of 45% KOH is added. The KOH is mixed with the flowing water by the use of a first premixer [10], which is preferably an inline, static mixer. Some amount of heat evolution from the process is caused by the heat of solution of the KOH. Static mixers are well known in the art. After the KOH is mixed with the water, approximately 442 gph of 28.4% NH₄OH is added to the flowing stream. The stream passes through a second premixer [20], which is preferably an inline static mixer. Then approximately 76 gph of acetic acid is added to the stream and the mixture flows through a first mixer [30] to provide further mixing. Then approximately 492 gph of 75% H₃PO₄ is added to the stream. After passing through a second mixer [40], the pH of the product is monitored at the end of the pipe. An electronic feedback control loop (not shown) is used to control the pumping rate of the KOH, NH₄OH, and/or acetic acid so that the pH stays within control parameters and no solids precipitate out of the mixture. To accommodate the added flows of each raw material at a relatively constant pressure, the diameter of the pipe at each addition point is preferably increased to allow for the added materials. As an alternate, the flow rate is preferably increased at each addition point. Using such a process, approximately 2,513 gph of product can be made.

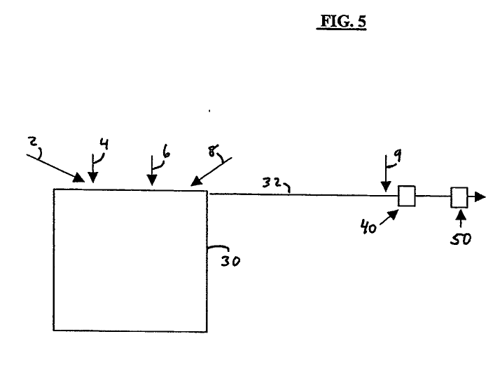

FIG. 5 shows an alternate embodiment of the portion of the continuous process to produce the liquid phosphate salt containing solution [42] of the present invention. In this process, the water [2] (approximately 935 gph), KOH [4] (approximately 599 gph), NH₄OH [6] (approximately 442 gph), and AcOH [8] (approximately 76 gph) are all added continuously using pumps (not shown) into a first mixer [30], which is preferably a stirred mixing vessel, and a continuous basic (pH>7) takeoff stream is pumped through a pipe into which the acidic H₃PO₄ [9] (approximately 492 gph) is added via a pump (not shown). After mixing the acid with the base solution, the mixture passes through a second mixer [40], which is preferably a static mixer, to ensure adequate reaction of the raw materials. The pH of the liquid phosphate salt containing solution [42] is monitored at the end of the pipe and An electronic feedback control loop (not shown) is used to control the pumping rate of the KOH, NH₄OH, and/or acetic acid so that the pH stays within control parameters and no solids precipitate out of the mixture.

Additionally, the phosphorus content of the liquid phosphate salt containing solution [42] is measured using a first p-count analyzer (not shown). The first p-count analyzer is in communication with the feed pump of the H₃PO₄ feedstock (not shown), so that it can adjust the flow rate of H₃PO₄ so that it is within a preselected range of a predetermined liquid phosphate phosphorus value. The liquid phosphate salt containing solution [42] then travels to a liquid phosphate salt containing solution run down tank [60] as shown in FIGS. 2-3. About 2,513 gph of liquid phosphate salt containing solution [42] can be made. Heating or cooling means can be added to the mixing vessel or the reaction pipe in order to achieve the desired temperature of the product.

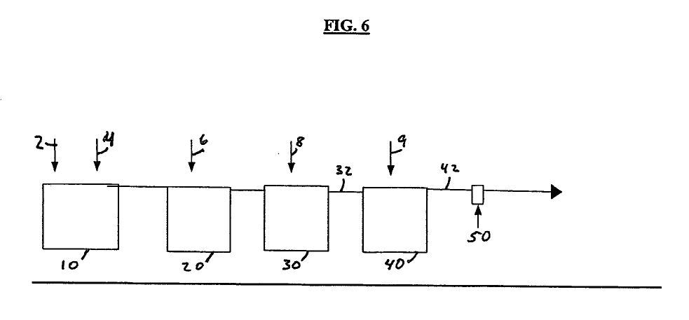

FIG. 6 shows an additional embodiment by which a continuous process can be accomplished; for instance, each raw material could be added into sequential tanks that are connected by an overflowing stream. Into the first stirred tank [11] would be pumped approximately 935 gph of water [2] along with approximately 569 gph of 45% KOH [4]. The first tank [11] would overflow into a second stirred tank [21], to which approximately 442 gph of 28.4% NH₄OH [6] is added. The contents of the second stirred tank [21] would then overflow into a third tank stirred tank [31] to which approximately 76 gph of AcOH [8] would be added. The contents of the third stirred tank [31] would overflow into the fourth stirred tank [41] in which 492 gph of 75% H₃PO₄ [9] would be added. A pH analyzer [50] would be used to monitor the pH of the product overflowing from the last tank and an electronic feedback loop (not shown) could be used to control the addition rate of the KOH, NH₄OH, and/or acetic acid such that the pH of the product would be within the preferred range of about 6 to about 8, more preferably from about 6.5 to about 7.5, most preferably from about 7.0 to about 7.2. At a pH above or below this range solid precipitants might form at room temperature.

Additionally, the phosphorus content of the liquid phosphate salt containing solution [42] is measured using a first p-count analyzer (not shown). The first p-count analyzer is in communication with the feed pump of the H₃PO₄ feedstock (not shown), so that it can adjust the flow rate of H₃PO₄ so that it is within a preselected range of a predetermined liquid phosphate phosphorus value. The liquid phosphate salt containing solution [42] then travels to a liquid phosphate salt containing solution run down tank [60] as shown in FIGS. 2-3. The volume of each tank can be adjusted so as to allow the correct residence time for the reaction to take place. Each tank can be individually cooled or heated as the process conditions require.

The description of the continuous process in the preceding paragraphs is not intended to limit the continuous process as to how it is implemented or finally carried out. For example, it is possible that rather than adding phosphoric acid and potassium hydroxide separately and making the potassium phosphate salts in solution, that a preformed potassium phosphate salt could be used in the continuous process. Such a variation would be within the scope of the present invention. Other variations in the physical states or salt forms of the feedstocks are contemplated and fall well within the scope of the present invention.

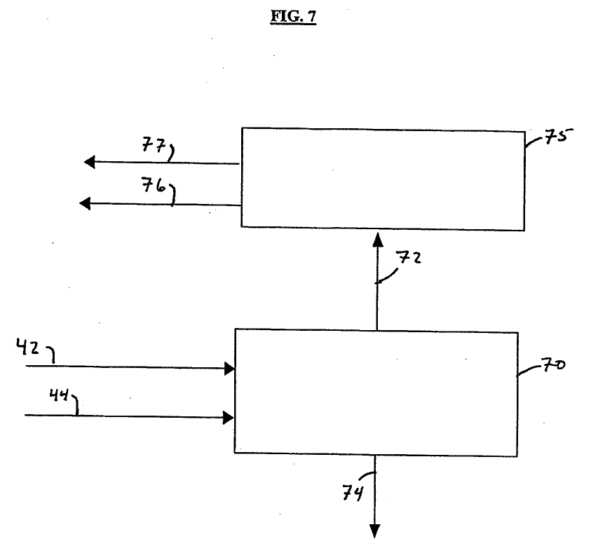

FIG. 7 represents an enlarged view of an embodiment of the drying chamber [70] from FIG. 2. The liquid phosphate salt containing solution [42] to be dried is introduced into the drying chamber [70] that is heated and or under vacuum. The liquid phosphate salt containing solution [42] can be preheated and can be under pressure. The liquid phosphate salt containing solution [42] is introduced into the drying chamber [70] preferably through spray nozzles that convert the liquid phosphate salt containing solution [42] into fine droplets. As the fine liquid droplets enter the drying chamber [70], the liquid portion of the solution is evaporated from the surface of the droplet and a plurality of particles form, producing a substantially water free solid phosphate salt product [74]. The water based vapor stream [72] is removed from the top portion of the chamber and the substantially water free solid phosphate salt product [74] collects at the bottom portion of the drying chamber [70]. The water based vapor stream [72] removed from the drying chamber [70] can be condensed and recycled back to the front of the operation to provide water of dilution for the substantially water free solid phosphate salt product [74]. Other volatile components of the liquid phosphate salt containing solution [42] such as acetic acid or ammonia can also be condensed along with the water, or the vapors can be separated through the use of a distillation column [75] to provide purified components of water [76] and recovered raw materials [77]. Each of these purified components can then be reintroduced into the front end of the process to make phosphate salt containing solution.

The liquid phosphate salt containing solution [42] can be heated under pressure in the line leading to the drying chamber [70]. Once introduced via spray into the drying chamber [70] under vacuum, the liquid portion of the liquid phosphate salt containing solution [42] would flash off and be condensed in the condenser while the solid portion of the liquid phosphate salt containing solution [42] would be collected as the substantially water free solid phosphate salt product [74] at the bottom of the drying chamber. The preferred temperature range of the liquid phosphate salt containing solution [42] for the operation of the drying process is from 25° C. to 300° C.; more preferably from 75° C. to 200° C.; most preferably from 100° C. to 190° C. The preferred pressure of the liquid phosphate salt containing solution [42] stream before entering the drying chamber [70] includes any pressure that would maintain the liquid phosphate salt containing solution [42] in its liquid state, depending on the temperature of the stream.

The substantially water free solid phosphate salt product [74], which will be a mixture of several different salts, can still contain water as water of hydration; such water of hydration can be necessary for the stable formation of such salt mixtures. The substantially water free solid phosphate salt product [74] can also contain portions of other volatile products such as acetic acid and ammonia. It is anticipated that volatile components such as water, ammonia, acetic acid, and any other components that can be found to be useful as a component of the final product of the process can be introduced separately in make-up streams [44] into the drying chamber [70] so as to maintain the appropriate concentration of such component in the final product of the inventive process. It is also anticipated that chemical additives that can be beneficial to the handling of the solid product can be introduced into the drying chamber [70], for instance flow improvers and additives that reduce the formation of dust.

For instance, the liquid phosphate salt containing solution [42] can contain ammonia and it can be necessary for the final solid product to contain ammonia, either as free ammonia or as a salt. The drying process may inadvertently lead to removal of most of the ammonia; this ammonia can be restored into the final product by introducing a stream of pure ammonia or ammonium hydroxide, or other ammonia-containing feedstock, into the drying chamber at such a concentration as to produce a substantially water free solid phosphate salt product [74] that contains the appropriate amount of ammonia. In the same way, water or steam can be introduced into the drying chamber to ensure that the dried substantially water free solid phosphate salt product [74] contains the appropriate amount of water of hydration, if necessary. The excess water, ammonia, or other product can be recovered with the water vapor from the chamber and recycled to the front end of the process.

In a preferred embodiment, the liquid phosphate salt containing solution [42] is produced continuously; the liquid product is then fed into a continuous process for making a substantially water free solid phosphate salt product [74]; the substantially water free solid phosphate salt product [74] is then either used as is, or mixed into a liquid petroleum or other combustible base oil or solid fuel for delivery into an engine or other combustion power device such as a furnace or boiler.

In another preferred embodiment, the liquid phosphate salt containing solution, made via a continuous process, is introduced into a continuous process to make liquid hydrocarbon-based phosphate salt containing product by removing the water from the liquid phosphate salt containing solution. Removal of the water can be accomplished using methods known in the art, such as via thin film evaporation or other means of distillation, as a continuous process. These two processes are preferred because the heat of solution plus the heat of reaction produced in making the liquid phosphate salt containing solution can be used in the next step of the process, either the spray drying step, or the water stripping step, thereby conserving energy. Because phosphate salt containing product is such a small portion of the final liquid oil based phosphate containing product, a very small continuous phosphate salt containing product reactor train could be used to make a very large volume of liquid hydrocarbon-based phosphate salt containing product.

In a “wet” continuous embodiment of the present invention, the particles could be formed in-situ to produce particles of intermediate size in the desired matrix. In this example, the initial particles are formed by dissolving the desired salts or, other hydrocarbon in soluble compounds, in a water parent solution. This solution is then emulsified with a carrier fluid, which can be the final desired matrix. The emulsion is then dehydrated with heat or vacuum or both to produce the initial particle dispersion.

In one specific embodiment, the final concentration of total phosphorous in the substantially water free solid phosphate salt product [74] is preferably about 1 to 20% by weight. A preferred concentration of total phosphorous in the substantially water free solid phosphate salt product [74] is about 5-17% by weight. A most preferred concentration of total phosphorous in the substantially water free solid phosphate salt product [74] is about 8 to 15% by weight.

The final concentration of total phosphorous in the oil based phosphate containing product is preferably about 3,500 ppm; a more preferred concentration is between 1,000 and 3,000 ppm.

The mixing of the liquid phosphate salt containing solution with the base stock hydrocarbon to make an emulsified water-in-oil mixture continuously could be conveniently accomplished by passing the mixture through a static mixer in a pipe, much as described for the mixing of the ingredients in the continuous production of liquid phosphate salt containing solution. Therefore, one embodiment of the present invention includes the continuous production of liquid phosphate salt containing solution in a pipe by adding the raw materials at various feed points in the pipe, mixing the raw materials using static mixers, and then feeding the finished liquid phosphate salt containing solution into a second pipe system where it can be mixed with the dispersants and base stock hydrocarbon for making the emulsified water-in-oil mixture. A static mixer can be used to achieve the production of the microemulsion in the mixture. The microemulsion is preferably pumped into a stripping column where the water is removed from the emulsified water-in-oil mixture.

Another embodiment of the present invention includes the production of liquid phosphate salt containing solution in a continuous process in a pipe as described above, followed by feeding the continuously produced liquid phosphate salt containing solution, internally heated by the reaction of the various feedstocks, into a spray drying unit where additional heating can be used to produce the substantially water free solid phosphorous salt product continuously. This substantially water free solid phosphorous containing product can be used as is, mixed with solid fuel, mixed with liquid hydrocarbon or other base stock. Preferably, if the diameter of the particles is too large for a given application, the solid can be further ground or milled in order to achieve the production of small nanometer-sized particles that can be used as is or mixed with a base stock hydrocarbon.

After production of the substantially water free solid phosphorous salt product, the substantially water free solid phosphorous salt product can be milled or ground to provide phosphate salt particles having sub-micron and below sized particles. The optimal particle size would range from 2 microns to less than 1 micron, preferably from less than 1 micron to less than 100 nanometers in diameter. The nano-sized particles of the solid product can then be added directly to the combustion chamber of the hydrocarbon fuel. Alternatively, the nano-sized particles of substantially water free solid phosphorous salt product can be dispersed or suspended in a carrier fluid, or dispersion liquid. In so doing, it is known that particles of less than 10 nm in diameter can be dispersed in liquids and are not visible to the naked eye. Methods of producing solid nano-sized particles are disclosed in U.S. Pat. No. 6,548,039 and U.S. Pat. No. 6,440,383, the disclosures of which are incorporated herein by reference.

In another aspect, the present invention relates to sub-micron and smaller particles, e.g., nano-sized particles, used in the dry state as combustion catalysts or modifiers to improve combustion resulting in reduced emissions or improved fuel economy or both. The particles preferably have a particle with a size of less than 1 micron, more preferably less than 0.1 micron and most preferably less than 0.01 micron. Particle size actually refers to a particle size distribution with the specified size being the average of the distribution. The average can be either a number average which is calculated based on the number of particles in each fraction of the distribution or weight average which is calculated from the weight of the particles in each fraction of the distribution. The ratio of the weight average particle size to the number average particle size is the dispersity.

Dispersity is a measure of the broadness of the distribution. It is preferred that the particle size distribution be as narrow as possible in order to achieve optimum performance. A particle dispersity of less than 5 is preferred. A dispersity of less than 3 is more preferred. And, a dispersity of less than 2 is most preferred.

In another preferred embodiment the substantially water free solid phosphate salt product can be dissolved in a volatile solvent in which it is soluble and then spray dried to produce the dried particle. The particle can be further reduced in size if necessary by any of the methods described above.

In another preferred embodiment the desired chemical composition of the particle can be formed in-situ by reaction of precursor chemicals in a volatile solvent in which the final product is soluble. The solution can then be spray dried and reduced as above. In this embodiment, the particle size is preferably less than 1 micron and the particles are in the dry state.

The chemical composition of the plurality of particles of the substantially water free solid phosphate salt product can be any inorganic salt or compound that provides a catalytic effect in hydrocarbon combustion processes such that the combustion emissions are reduced or fuel economy is improved, or both. The chemical composition preferably does not include the elements of platinum, palladium or cerium. Preferred chemical compositions are any of the alkali metal salts of phosphoric acid. Other preferred compositions are any of the ammonium salts of phosphoric acid. In another preferred composition the particles can be mixtures of ammonium and alkali metal salts of phosphoric acid. In another preferred embodiment the particles can be alkali metal or ammonium salts or mixtures thereof of boric acid or other suitable boron containing compounds.

In a general preferred embodiment the particles can contain the elements of Groups IA, IIA, IIIA, IVA, VA, IIIB, IVB, VB, VIIB, VIIB, and VIII of the Periodic Table of Elements, in any form including salts, covalent inorganic compounds, or in elemental form, with the exception of Pt, Pd and Ce containing compositions. The particles can also be organic compounds of the foregoing elements.

In a “wet” embodiment of the continuous process, an oil based phosphate containing product is formed by preparing the liquid phosphate salt containing solution either from the “salts” process or in situ using the “exothermic” process from the appropriate acids and bases. The liquid phosphate salt containing solution is mixed with a base stock hydrocarbon in which the salt solution is not soluble to form an emulsified water-in-oil mixture. High shear mixing is applied to the emulsified water-in-oil mixture such that when the emulsion is dehydrated the resulting particle dispersion contains particles in the sub-micron and smaller range. In the preferred embodiment, the preparation of the liquid phosphate salt containing solution is continuous and formation of the micro-emulsion is continuous, using an in-line static mixer.

### EXAMPLE

To a Black & Decker high speed stainless steel blender was charged 306.4 grams of Calpar 100 base oil, 25.1 grams of a dispersant, 25.2 grams of EnviroFuels™ EF-1000 (liquid phosphate salt containing solution) available from EviroFuels, LLC of Houston, Tex., and 46.5 grams of kerosene.

The mixture was blended on high speed (setting 5) for 8 minutes. The temperature rose from ambient to 45° C. during the shearing process.

The resulting bright white micro emulsion was charged to an 800 ml beaker equipped with a magnetic stir bar.

On a magnetic stir hot/plate the emulsion was heated to 150° C. over a 20 minute period to remove the water and dehydrate the emulsion. The mixture became clear at 118° C. after 22.6 grams of water had been removed. Heating was continued and the mixture became hazy. A total of 29.9 grams of water was removed by the time the temperature reached 150° C.

The mixture was allowed to cool and became clear on cooling.

Over 90% of the resulting particles dispersed in the base oil phase were less than 0.2 microns. This is compared to less than 10% of the particles less than 2 microns when low shear was used.

These dry particles can be used as fuel additives, catalysts, and other treatment aids to improve combustion and reduce emissions. The fuels can be any hydrocarbon type fuel and can be either gas, liquid or solid or any combinations thereof. Additionally, the particles can be added directly to the combustion chamber or zones in any manner applicable including mixing with the fuel (fuel borne), mixing with the air, adding directly as a separate stream, or any combinations thereof.

As mentioned above, the nano-sized phosphate salt particles can be dispersed in a matrix in which the particles are not soluble. One example of such a dispersion matrix is mineral oil.

In another embodiment, intermediate sized particles of the phosphate salts can be mechanically milled or ground directly to the desired sub-micron or nano-particle size in the same matrix in which they were formed.

An alternate embodiment is directed to forming the particles at high concentrations in one matrix, grinding the particles in this matrix and then diluting with another preferred matrix, especially if the initial matrix might provide an advantage in the milling or grinding step over the final preferred matrix.

In another alternate embodiment, the initial solid particle is directly slurried into a matrix in which the particles are insoluble, such as a mineral oil, as opposed to the in-situ formation described above. The particles are then milled or ground to the desired size in one-step or in multi-grinding steps as is mechanically required.

In another embodiment the particles could be slurried in a suitable or preferred grinding matrix and then diluted with another fluid that might be more suitable for the final application.

The phosphate salt particles or compounds in the sub-micron or smaller size range in matrixes in which the particles are not soluble. The particle dispersions can be made in batch processes, continuous processes, combination of batch-continuous processes, or in continuous stirred tank reactor system (CSTR), or in any manner that produces a particle dispersion of the active compound or agent in a matrix such that the average particle size is below 1 micron, preferably below 0.5 microns and more preferably below 0.01 micron.

These dispersions are applicable for use as fuel additives, catalysts and other treatment aids to improve combustion and reduce emissions. The fuels can be any hydrocarbon type fuel and can be either gas, liquid or solid or any combinations thereof. The particle dispersions can be added to the combustion chamber or zones in any manner applicable including mixing with the fuel (fuel borne), mixing with the air, adding directly as a separate stream, or any combinations thereof.

The use of the sub-micron and smaller particle dispersions, of the current invention, have advantages over the prior art of increased efficiency. It is believed that these dispersions when present in the combustion chamber or zone will cause a one or both of a greater decrease in emissions or a greater improvement in fuel economy.

The combustion device can be an internal combustion engine, a turbine, an open flame, or any combustion device in which hydrocarbon fuel is used to convert chemical energy to work or power or heat.

Hydrocarbon fuel is any fuel that contains the elements of hydrogen and carbon. In addition, to the elements of hydrogen and carbon, the hydrocarbon fuel can also contain other elements including but not limited to oxygen and nitrogen.

While the invention has been shown or described in only some of its forms, it should be apparent to those skilled in the art that it is not so limited, but is susceptible to various changes without departing from the scope of the invention.

What is claimed is:

1. A continuous process for producing an oil based phosphate containing product, the continuous process comprising:
mixing a predetermined amount of water, [Y]OH, [Z]OH, and AcOH in a first mixer to create a base stream, wherein [Y] is a cation and [Z] is selected from the group consisting of NH₄, NHOH and an amine;
mixing the base stream with an orthophosphoric acid using a second mixer to create a liquid phosphate salt containing solution, wherein the orthophosphoric acid is selected from the group consisting of [Y]H₂PO₄, [Y]HPO₄, [NH₄]₂HPO₄, and combinations thereof, wherein [Y] is a cation;
determining pH of the liquid phosphate salt containing solution and comparing the pH of the liquid phosphate salt containing solution to a predetermined liquid phosphate pH value;
providing means for adjusting the pH of the liquid phosphate salt containing solution operable to modify the pH of the liquid phosphate salt containing solution within a preselected range of the predetermined liquid phosphate pH value;
drying and granulating the liquid phosphate salt containing solution to create a water based vapor stream and a substantially water-free solid phosphoric salt product, the substantially water-free solid phosphoric salt product consisting of a plurality of particles and the plurality of particles having a size distribution of particles, a substantial amount of the particles having a diameter smaller than about 100 nanometers;
mixing the substantially water-free solid phosphoric salt product with a base stock hydrocarbon using a high shear mixer to form an oil based phosphate containing product; and
conducting all of the above steps as a continuous process.

2. The continuous process of claim 1, further comprising removing substantially all particles exceeding a predetermined size in diameter as large particles from the substantially water-free solid phosphoric salt product and recycling the large particles into the first mixer.

3. The continuous process of claim 1, further comprising:
determining the phosphorus content of the liquid phosphate salt containing solution using a first p-count analyzer and comparing the phosphorus content of the liquid phosphate salt containing solution to a predetermined liquid phosphate phosphorus value;
providing means for adjusting the phosphorus content of the liquid phosphate salt containing solution operable to modify the phosphorus content of the liquid phosphate salt containing solution within a preselected range of the predetermined liquid phosphate phosphorus value;
determining the phosphorus content of the oil based phosphate containing product using a second p-count analyzer and comparing the phosphorus content of the oil based phosphate containing product to a predetermined oil based phosphorus value; and
providing means for adjusting the phosphorus content of the oil based phosphate containing product operable to modify the phosphorus content of the oil based phosphate containing product within a preselected range of the predetermined oil based phosphorus value.

4. The continuous process of claim 1, wherein the preselected range of the predetermined liquid phosphate pH value is from about 6.0 to about 8.0.

5. The continuous process of claim 1, wherein the preselected range of the predetermined liquid phosphate pH value is from about 6.5 to about 7.5.

6. The continuous process of claim 1, wherein the preselected range of the predetermined liquid phosphate pH value is from about 7.0 to about 7.2.

7. A continuous process for producing an oil based phosphate containing product, the continuous process comprising:
mixing a predetermined amount of water, [Y]OH, [Z]OH, and AcOH in a first mixer to create a base stream, wherein [Y] is a cation and [Z] is selected from the group consisting of NH₄, NHOH and an amine;
mixing the base stream with an orthophosphoric acid using a second mixer to create a liquid phosphate salt containing solution, wherein the orthophosphoric acid is selected from the group consisting of [Y]H₂PO₄, [Y]HPO₄, [NH₄]₂HPO₄, and combinations thereof, wherein [Y] is a cation;
determining pH of the liquid phosphate salt containing solution and comparing the pH of the liquid phosphate salt containing solution to a predetermined liquid phosphate pH value;
providing means for adjusting the pH of the liquid phosphate salt containing solution operable to modify the pH of the liquid phosphate salt containing solution within a preselected range of the predetermined liquid phosphate pH value;
mixing the liquid phosphate salt containing solution with a base stock hydrocarbon using a wet high shear mixer to form an emulsified water-in-oil mixture;
drying the emulsified water-in-oil mixture to create a water based vapor stream and a substantially water-reduced emulsified mixture, wherein the substantially water-reduced emulsified mixture contains an effective amount of water to promote water of hydration;
determining the water content of the substantially water-reduced emulsified mixture using a water content analyzer and comparing the water content of the substantially water-reduced emulsified mixture to a predetermined water value;
providing means for adjusting the water content of the substantially water-reduced emulsified mixture operable to modify the water content of the substantially water-reduced emulsified mixture within a preselected range of the predetermined water value;
grinding the substantially water-reduced emulsified mixture to produce an oil based phosphate containing product, the oil based phosphate containing product consisting of a plurality of particles and the plurality of particles having a size distribution of particles, a substantial amount of the particles having a diameter smaller than about 100 nanometers; and
conducting all of the above steps as a continuous process.

8. The continuous process of claim 7, further comprising:
analyzing the diameters of the plurality of particles of the oil based phosphate containing product using a wet particle analyzer and comparing the diameters of the plurality of particles of the oil based phosphate containing product to a predetermined diameter value; and
providing means for adjusting the diameters of the plurality of particles of the oil based phosphate containing product operable to modify the diameters of the plurality of particles of the oil based phosphate containing product within a preselected range of the predetermined diameter value.

9. The process of claim 7, further comprising:
determining the phosphorus content of the liquid phosphate salt containing solution using a first p-count analyzer and comparing the phosphorus content of the liquid phosphate salt containing solution to a predetermined liquid phosphate phosphorus value;
providing means for adjusting the phosphorus content of the liquid phosphate salt containing solution operable to modify the phosphorus content of the liquid phosphate salt containing solution within a preselected range of the predetermined liquid phosphate phosphorus value;
determining the phosphorus content of the emulsified water-in-oil mixture using a second wet p-count analyzer and comparing the phosphorus content of the emulsified water-in-oil mixture to a predetermined emulsified water-in-oil phosphorus value; and
providing means for adjusting the phosphorus content of the emulsified water-in-oil mixture operable to modify the phosphorus content of the emulsified water-in-oil mixture within a preselected range of the predetermined water-in-oil phosphorus value.

10. The continuous process of claim 7, wherein the preselected range of the predetermined liquid phosphate pH value is from about 6.0 to about 8.0.

11. The continuous process of claim 7, wherein the preselected range of the predetermined liquid phosphate pH value is from about 6.5 to about 7.5.

12. The continuous process of claim 7, wherein the preselected range of the predetermined liquid phosphate pH value is from about 7.0 to about 7.2.

13. A continuous process for producing an oil based phosphate containing product, the continuous process comprising:
mixing a predetermined amount of water with salts in a first mixer to form an intermediate solution, the salts are selected from the group consisting of [Z]₂B₄O₇, [Y]H₂PO₄, [Y]₂HPO₄, [NH₄]₂HPO₄, [X]C₂H₃O₂, [NR₄]₂HPO₄, [Y]₂NH₄PO₄, [Y][NH₄]₂PO₄, and combinations thereof, wherein [Z] is a cation; wherein [Y] is a cation; [X] is selected from the group consisting of a cation, NH₄, and combinations thereof; and R is selected from the group consisting of hydrogen, alkyl groups and combinations thereof;
determining pH of the intermediate mixture and comparing the pH of the intermediate mixture to a predetermined liquid phosphate pH value;
providing means for adjusting the pH of the intermediate mixture operable to modify the pH of the intermediate mixture within a preselected range of the predetermined liquid phosphate pH value;
drying and granulating the intermediate mixture at a temperature within a preset temperature range to create a water based vapor stream and a substantially water-free solid phosphoric salt product, the substantially water-free solid phosphoric salt product consisting of a plurality of particles and the plurality of particles having a size distribution of particles, a substantial amount of the particles having a diameter smaller than about 100 nanometers;
mixing the substantially water-free solid phosphoric salt product with a base stock hydrocarbon using a high shear mixer to form an oil based phosphate containing product; and
conducting all of the above steps as a continuous process.

14. The continuous process of claim 13, further comprising removing any particles exceeding a predetermined size in diameter from the substantially water-free solid phosphoric salt product and recycling into the first mixer.

15. The continuous process of claim 13, further comprising:
determining the phosphorus content of the intermediate solution using a first p-count analyzer and comparing the phosphorus content of the intermediate solution to a predetermined liquid phosphate phosphorus value;
providing means for adjusting the phosphorus content of the intermediate solution operable to modify the phosphorus content of the intermediate solution within a preselected range of the predetermined liquid phosphate phosphorus value;
determining the phosphorus content of the oil based phosphate containing product using a second p-count analyzer and comparing the phosphorus content of the oil based phosphate containing product to a predetermined oil based phosphorus value; and
providing means for adjusting the phosphorus content of the oil based phosphate containing product operable to modify the phosphorus content of the oil based phosphate containing product within a preselected range of the predetermined oil based phosphorus value.

16. A continuous process for producing an oil based phosphate containing product, the continuous process comprising:
mixing a predetermined amount of water with salts to form an intermediate solution, the salts are selected from the group consisting of [Z]₂B₄O₇, [Y]H₂PO₄, [Y]₂HPO₄, [NH₄]₂HPO₄, [X]C₂H₃O₂, [NR₄]₂HPO₄, [Y]₂NH₄PO₄, [Y][NH₄]₂PO₄, and combinations thereof, wherein [Z] is a cation; wherein [Y] is a cation; [X] is selected from the group consisting of a cation, NH₄, and combinations thereof; and R is selected from the group consisting of hydrogen, alkyl groups and combinations thereof;
determining pH of the intermediate mixture and comparing the pH of the intermediate mixture to a predetermined liquid phosphate pH value;
providing means for adjusting the pH of the intermediate mixture operable to modify the pH of the intermediate mixture within a preselected range of the predetermined liquid phosphate pH value;
mixing the intermediate mixture with a base stock hydrocarbon using a wet high shear mixer to form an emulsified water-in-oil mixture;
drying the emulsified water-in-oil mixture at a temperature within a preset temperature range to create a water based vapor stream and a substantially water-reduced emulsified mixture, wherein the substantially water-reduced emulsified mixture contains an effective amount of water to promote water of hydration;
determining the water content of the substantially water-reduced emulsified mixture using a water content analyzer and comparing the water content of the substantially water-reduced emulsified mixture to a predetermined water value;
providing means for adjusting the water content of the substantially water-reduced emulsified mixture operable to modify the water content of the substantially water-reduced emulsified mixture within a preselected range of the predetermined water value;
grinding the substantially water-reduced emulsified mixture to produce an oil based phosphate containing product, the oil based phosphate containing product consisting of a plurality of particles and the plurality of particles having a size distribution of particles, a substantial amount of the particles having a diameter smaller than about 100 nanometers; and
conducting all of the above steps as a continuous process.

17. The continuous process of claim 16, further comprising:
analyzing the diameters of the plurality of particles of the oil based phosphate containing product using a wet particle analyzer and comparing the diameters of the plurality of particles of the oil based phosphate containing product to a predetermined diameter value; and
providing means for adjusting the diameters of the plurality of particles of the oil based phosphate containing product operable to modify the diameters of the plurality of particles of the oil based phosphate containing product within a preselected range of the predetermined diameter value.

18. The continuous process of claim 16, further comprising:
determining the phosphorus content of the intermediate solution using a first p-count analyzer and comparing the phosphorus content of the intermediate solution to a predetermined liquid phosphate phosphorus value;
providing means for adjusting the phosphorus content of the intermediate solution operable to modify the phosphorus content of the intermediate solution within a preselected range of the predetermined liquid phosphate phosphorus value;
determining the phosphorus content of the emulsified water-in-oil mixture using a second wet p-count analyzer and comparing the phosphorus content of the emulsified water-in-oil mixture to a predetermined emulsified water-in-oil phosphorus value; and
providing means for adjusting the phosphorus content of the emulsified water-in-oil mixture operable to modify the phosphorus content of the emulsified water-in-oil mixture within a preselected range of the predetermined water-in-oil phosphorus value.
